(19) United States
(12) Patent Application Publication
(10) Pub. No.: US 2009/0087549 A1
(43) Pub. Date: Apr. 2, 2009

(54) SELECTIVE COATING OF FUEL CELL ELECTROCATALYST

(75) Inventors: Yanxiu Zhou, Phoenix, AZ (US); Chowdary Ramesh Koripella, Scottsdale, AZ (US); Kajal Parekh, Union City, NJ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/862,425

(22) Filed: Sep. 27, 2007

(51) Int. Cl. B05D 1/18; B05D 3/00

(52) U.S. Cl. 427/115; 427/58

(57) ABSTRACT

A method is provided for selectively coating a catalyst layer (158) on an electrode of a fuel cell. A porous conductive material (154) comprising gold is formed overlying a portion of a dielectric material (114) to form the electrode. The porous conductive material (154) and the dielectric material (114) are coated with the catalyst layer (158) comprising a carbon supported platinum. The catalyst layer (158) is washed with a solvent to substantially remove the catalyst layer (158) from the dielectric material (114). Optionally, an ionomer component is diffused into the catalyst layer (158) remaining on the porous conductive material (154). The catalyst coated (158) circular channels (156) are then filled with an electrolyte layer (162).

### RELATED APPLICATIONS

This application relates to U.S. application Ser. No. 11/363,790, Integrated Micro Fuel Cell Apparatus, filed 28 Feb. 2006, U.S. application Ser. No. 11/479,737, Fuel Cell Having Patterned Solid Proton Conducting Electrolytes, filed 30 Jun. 2006, U.S. application Ser. No. 11/519,553, Method for Forming a Micro Fuel Cell, filed 12 Sep. 2006, U.S. application Ser. No. 11/604,035, Method for Forming a Micro Fuel Cell, filed 20 Nov. 2006, and U.S. application Ser. No. 11/669,720, Micro Fuel Cell Having Macroporous Metal Current Collectors, filed 31 Jan. 2007.

### FIELD

The present invention generally relates to fuel cells and more particularly to a method of selectively coating an electrocatalyst layer in a gold based micro fuel cell.

### BACKGROUND

Rechargeable batteries are currently the primary power source for cell phones and various other portable electronic devices. The energy stored in the batteries is limited. It is determined by the energy density (Wh/L) of the storage material, its chemistry, and the volume of the battery. For example, for a typical Li ion cell phone battery with a 250 Wh/L energy density, a 10 cc battery would store 2.5 Wh of energy. Depending upon the usage, the energy could last for a few hours to a few days. Recharging always requires access to an electrical outlet. The limited amount of stored energy and the frequent recharging are major inconveniences associated with batteries. Accordingly, there is a need for a longer lasting, easily recharging solution for cell phone power sources. One approach to fulfill this need is to have a hybrid power source with a rechargeable battery and a method to trickle charge the battery. Important considerations for an energy conversion device to recharge the battery include power density, energy density, size, and the efficiency of energy conversion.

Energy harvesting methods such as solar cells, thermoelectric generators using ambient temperature fluctuations, and piezoelectric generators using natural vibrations are very attractive power sources to trickle charge a battery. However, the energy generated by these methods is small, usually only a few milliwatts. In the regime of interest, namely, a few hundred milliwatts, this dictates that a large volume is required to generate sufficient power, making it unattractive for cell phone type applications.

An alternative approach is to carry a high energy density fuel and convert this fuel energy with high efficiency into electrical energy to recharge the battery. Radioactive isotope fuels with high energy density are being investigated for portable power sources. However, with this approach the power densities are low and there also are safety concerns associated with the radioactive materials. This is an attractive power source for remote sensor-type applications, but not for cell phone power sources. Among the various other energy conversion technologies, the most attractive one is fuel cell technology because of its high efficiency of energy conversion and the demonstrated feasibility to miniaturize with high efficiency.

Fuel cells with active control systems and those capable of operating at high temperatures are complex systems and are very difficult to miniaturize to the 2-5 cc volume needed for cell phone application. Examples of these include active control direct methanol or formic acid fuel cells (DMFC or DFAFC), hydrogen fuel cells, reformed hydrogen fuel cells (RHFC), and solid oxide fuel cells (SOFC). Passive air-breathing hydrogen fuel cells, passive DMFC or DFAFC, and biofuel cells are attractive systems for this application. However, in addition to the miniaturization issues, other concerns include supply of hydrogen for hydrogen fuel cells, lifetime and energy density for passive DMFC and DFAFC, and lifetime, energy density and power density with biofuel cells.

Conventional hydrogen, DMFC and DFAFC designs comprise planar, stacked layers for each cell, including current collectors, gas diffusion layers (GDLs), electrocatalyst layers, and proton conducting membrane (electrolyte). The combination of GDLs, electrocatalyst layers, and proton conducting membrane is known in the art as a membrane-electrode-assembly (MEA). Many methods have been reported for fabricating MEAs for conventional fuel cells, and many types of MEAs are commercially available. In a typical fabrication, an electrocatalyst supported on carbon is dispersed with an ionomer, Nafion® for example, and is either coated on both sides of the electrolyte directly, or applied to one side of a GDL which is then hot-pressed to the electrolyte, or simply assembled with an electrolyte in some test hardware. While this mixture of electrocatalyst/carbon support/ionomer achieves a three-phase boundary between fuel, electron conductor, and proton conductor, the number of three point contacts varies widely according to the fabrication method used, and can thereby limit oxygen reduction reaction kinetics and the maximum power available from the fuel cell. Furthermore, the thickness of the catalyst/carbon support/ionomer is often greater than ten micrometers and contributes to increased iR losses that result in a voltage drop that lowers the power output of the fuel cell. Fuel and water diffusion through the electrocatalyst layer is poor (permeability of less than 0.1), resulting in mass-transfer limitations which also decrease the power available from the cell.

For most applications, individual cells are stacked for higher power, redundancy, and reliability. Stack hardware typically comprises graphite, carbon or carbon composites, polymeric materials, metal such as titanium and stainless steel, and ceramic. The functional area of the stacked layers is restricted, usually on the perimeter, by vias for bolting the structure together and accommodating the passage of fuel and an oxidant along and between cells. Additionally, the planar, stacked cells derive power only from a fuel/oxidant interchange in a cross-sectional area (x and y coordinates).

In order to design a fuel cell/battery hybrid power source in the same volume as a typical mobile device battery (10 cc-2.5 Wh), both a smaller battery and a fuel cell with high power density and efficiency would be required to achieve an overall energy density higher than that of the battery alone. For example, for a 4-5 cc (1.0-1.25 Wh) battery to meet the peak demands of the phone, the fuel cell would need to fit in 1-2 cc, with the fuel taking up the rest of the volume. The power output of the fuel cell needs to be 0.5 W or higher to be able to recharge the battery in a reasonable time. Most development activities on small fuel cells are attempts to miniaturize traditional fuel cell designs, and the resultant systems are still too big for mobile applications. A few micro fuel cell development activities have been disclosed using traditional silicon processing methods in planar fuel cell configurations, and in a few cases, porous silicon is employed to increase the surface area and power densities. See, for example, U.S. Patent/Publication Numbers 2004/0185323, 2004/0058226, 6,541,149, and 2003/0003347. However, the power densities of the air-breathing planar hydrogen fuel cells are typically in the range of 50-100 mW/cm², and to produce 500 mW with this device would require 5 cm² or more active area. Further, the operating voltage of a single fuel cell is in the range of 0.5-0.7V. At least four to five cells would need to be stacked in series to bring the fuel cell operating voltage to 2-3V and for efficient DC-DC conversion to 4V in order to charge the Li ion battery. Therefore, the traditional planar fuel cell approach will not be able to meet the requirements in a 1-2 cc volume for a fuel cell in the fuel cell/battery hybrid power source for cell phone use.

Meeting the challenges of a fuel cell battery hybrid power source for a cell phone requires a redesign of the traditional fuel cell. One approach is to design a 3D fuel cell, rather than a planar (2D) fuel cell. With sufficient aspect ratio and geometry, it would be possible to build a stack of hundreds of cells in series in the 1-2 cc space defined by the portable device. However, traditional methods of MEA and fuel cell fabrication are not viable for fabricating a micron-sized, 3D fuel cell. Therefore, viable methods for the fabrication of high aspect ratio, micron sized 3D membrane electrode assemblies suitable for use in a fuel cell/battery hybrid power source are needed. In a related patent application U.S. application Ser. No. 11/669,720, Micro Fuel Cell Having Macroporous Metal Current Collectors, filed 31 Jan. 2007, a method to fabricate high aspect ratio 3D porous gold structures that can serve as current collector, gas diffusion layer and also as anode and cathode surfaces to fabricate the micro fuel cells was described. Methods to apply electrocatalyst on porous gold anode and cathode surfaces and methods to apply electrolyte material therebetween are required.

In a typical fuel cell, the fabrication of MEA involves applying the electrocatalyst layers on both sides of a solid polymer electrolyte membrane. Methods such as screen printing or spray painting methods can be used to apply the electrocatalyst on solid polymer membranes. In micro fuel cells, which require in-situ formation of electrolyte and electrocatalyst on small feature sizes, new fabrication methods are required. For example, it may be convenient in micro fuel cells fabrication to apply the electrocatalyst first to a highly conductive porous gas diffusion layer on the cathode and anode portions, followed by the incorporation of electrolyte material between the anode and cathodes. With high aspect ratio, micron sized 3D features, a process is required to apply the electrocatalyst on the cathode and anode walls without causing a short circuit thereacross.

Accordingly, it is desirable to provide a method of fabrication of an electrocatalyst layer on the anode and cathode walls of conductive porous gold surfaces without causing any electrical short circuit between them in high aspect ratio 3D micro fuel cell power sources. This invention is illustrated in the fabrication of an integrated micro fuel cell apparatus that derives power from a three-dimensional fuel/oxidant interchange having increased surface area and readily provide fuel and oxidant to a micro fuel cell through current collectors as well. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIGS. 1-7 and 9-11, and 14-16 are partial cross-sectional views of two fuel cells fabricated in accordance with an exemplary embodiment;

FIG. 8 is a partial cross-sectional top view taken along the line 8-8 of FIG. 7;

FIG. 12 is a picture taken during fabrication of the exemplary embodiment;

FIG. 13 is a flow chart in accordance with an exemplary embodiment; and

FIG. 17 is a partial cross-sectional top view taken along the line 15-15 of FIG. 15.

### DETAILED DESCRIPTION

A method is described for coating an electrocatalyst layer on a porous gold material forming a pedestal defining an anode and a cathode of a fuel cell. The electrocatalyst is a carbon supported platinum that, in addition to forming on the gold pedestal, also undesirably forms on the dielectric material. Since gold has high adsorption ability to any nearby carbonaceous molecules within a few seconds, this enables selectively application of coat carbon supported platinum to porous gold electrodes; however, dielectric material, e.g. silica, does not have such properties. The structure may be washed, substantially removing the carbon supported platinum from the dielectric material while leaving a coating of electrocatalyst on the gold pedestal surface.

The following detailed description is merely exemplary in nature and is not intended to limit the invention or the application and uses of the invention. Furthermore, there is no intention to be bound by any theory presented in the preceding background or the following detailed description.

The main components of a fuel cell device are a proton conducting electrolyte separating the reactant gases of the anode and cathode regions, an electrocatalyst which helps in the oxidation and reduction of the gas species at the anode and cathode of the fuel cell, a gas diffusion layer (GDL) to provide uniform reactant gas access to the anode and cathode and removal of gaseous or liquid by-products from the electrocatalyst, and a current collector for efficient collection and transportation of electrons to a load connected across the fuel cell. In traditional fuel cells, the membrane-electrode assembly comprises a sandwich structure of cathode GDL and cathode electrocatalyst, proton conducting electrolyte membrane, anode electrocatalyst, and anode GDL. The electrocatalyst is a hybrid material composed of catalyst, e.g., platinum or platinum supported on carbon, as well as platinum alloys, and ionomer, which is applied as an “ink” in water/alcohol solvent either directly to each side of the proton conducting electrolyte, or to the gas diffusion materials. Application of the electrocatalyst can be done by hand, spraying, inkjet printing, casting, or other methods known in the art. In the case of the former, gas diffusion material is added to each side, often by hot-pressing, and in the latter, the electrocatalyst-coated gas diffusion material is placed against each side of the proton conduction electrolyte, often with hot-pressing. As the dimensions of the fuel cell device decrease to the realm of micro fuel cells, it is increasingly difficult, and ultimately impossible, to employ these methods for the fabrication of a membrane electrode assembly. As with traditional, larger fuel cells, in fabrication of the micro fuel cell structures, the design, structure, and processing of the electrolyte and electrocatalyst are critical to high energy and power densities, and improved lifetime and reliability. Few methods have been described in the literature for the fabrication of a microfuel cell with dimensions less than the millimeter scale, and few of these methods are amenable to 3D geometries. A process is described herein, and as disclosed in U.S. application Ser. No. 11/669,720, Micro Fuel Cell Having Macroporous Metal Current Collectors, filed 31 Jan. 2007, to fabricate a macroporous 3D microstructure which functions as a hybrid current collector, gas diffusion layer and electrocatalyst for use in micro fuel cell devices. In accordance with an exemplary embodiment, a process is described herein to apply the electrocatalyst coating on the porous gold anode and cathode portions of the micro fuel cell structure. More specifically, a process is described for applying the electrocatalyst comprising a carbon supported platinum from a solution containing a fine dispersion of the catalyst powder in a suitable solvent onto the anode and cathode porous gold pedestals and a dielectric material support therebetween, and easily removing it from the dielectric material by simply washing it away without substantially removing any from the gold pedestal, leaving a desired catalyst coating on the same. The improved surface area of the high aspect ratio 3D micro fuel cell results in enhanced electrochemical contact area, improved 3-phase contact, and lower iR losses compared to traditional current collector-GDL-electrocatalyst structures. The three-dimensional fuel cell may be integrated as a plurality of micro fuel cells.

Conventional micro fuel cells or micro fuel cells comprising high aspect ratio three dimensional anodes and cathodes with sub-100 micron dimension provide a high surface area with good three-phase zone and high catalyst utilization. At these small dimensions, precise alignment of the anode, cathode, electrolyte and current collectors is required to prevent shorting of the cells. This alignment may be accomplished by semiconductor processing methods used in integrated circuit processing. Functional cells may also be fabricated in ceramic, glass or polymer substrates. This method of fabricating a three-dimensional micro fuel cell has a surface area greater than the substrate and, therefore, higher power density per unit volume. A more detailed description to illustrate the use of the hybrid structure of this invention follows.

The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

Parallel micro fuel cells in three dimensions fabricated using optical lithography processes typically used in semiconductor integrated circuit processing just described produces fuel cells with the required power density in a small volume. The cells may be connected in parallel or in series to provide the required output voltage. Functional micro fuel cells are fabricated in micro arrays (formed as pedestals) in the substrate. The anode/cathode ion exchange occurs in three dimensions with the anode and cathode areas separated by an insulator. Gasses comprising an oxidant, e.g., ambient air, and a fuel, e.g., hydrogen, are supplied on opposed sides of the substrate. A porous barrier is created between a porous metal in the hydrogen receiving section and the electrocatalyst. A vertical channel (via) is created by front side processing before fabricating the fuel cell structure on the top allow the precise alignment of the hydrogen fuel access hole under the anode, with this method, without the need for higher dimensional tolerances required for the front to back alignment process, allows for the fabrication of much smaller size high aspect ratio cells.

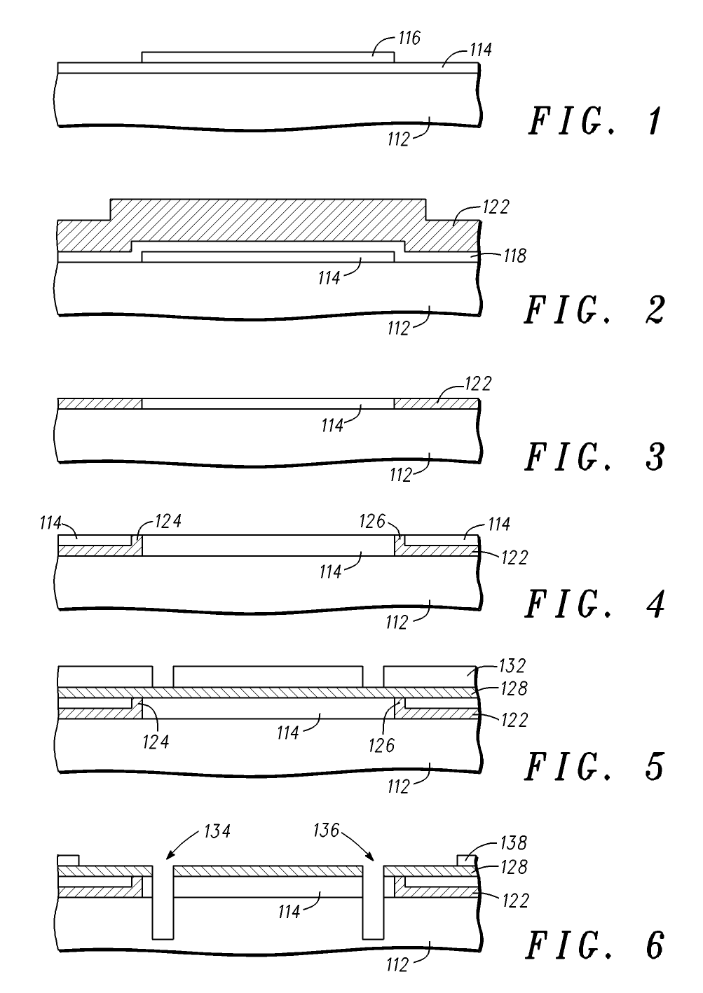

The exemplary embodiment described herein illustrate exemplary processes wherein a macroporous current collector is created in the hydrogen receiving section and/or the oxidant section in the fabrication of fuel cells with a semiconductor-like process on silicon, glass, ceramic, plastic, metallic, or a flexible substrate. Referring to FIG. 1, a thin layer 114 of insulating film, preferably a tetraethyl orthosilicate (TEOS) oxide (OC₂H₅)₄, is deposited on a substrate 112 to provide insulation for subsequent metallization layers which may be an electrical back plane (for I/O connections, current traces, etc.). The thickness of the thin layer 114 may be in the range of 0.1 to 1.0 micrometers, but preferably would be 0.5 micrometers. An optional insulating layer may be formed between the substrate 112 and the thin layer 114. A photoresist 116 is formed and patterned (FIG. 1) on the TEOS oxide layer 114 and the TEOS oxide layer 114 is etched (FIG. 2) by dry or wet chemical methods. The photoresist 116 is removed and a tantalum/copper layer 118, for example, is deposited on the substrate 112 and the TEOS oxide layer 114 to act as a seed layer for the deposition of a metal layer 122 for providing contacts to elements described hereinafter. The thickness of the tantalum/copper layer 118 may be in the range of 0.05 to 0.5 micrometers, but preferably would be 0.1 micrometers. The metal layer 122 may have a thickness in the range of 0.05-2.0 micrometer, but preferably is 1.0 micrometer. Metals for the metal layer 122 may include, e.g., gold, platinum, silver, palladium, ruthenium, and nickel, but preferably would comprise copper.

The metal layer 122 is patterned with a chemical mechanical polish (FIG. 3), and further similar processing in a manner known to those skilled in the art resulting in the formation of vias 124, 126 integral to the metal layer 122 (FIG. 4). It should be noted that a lift off based process may be used to form the patterned layer 122 and vias 124, 126.

Referring to FIG. 5, in accordance with the exemplary embodiment, an etch stop film 128 having a thickness of about 0.1 to 10.0 micrometers is formed by deposition on the TEOS oxide layer 114 and the vias 124, 126. The film 128 preferably comprises titanium/gold, but may comprise any material to selectively deep silicon etch. Another photoresist 132 is formed and the pattern is transferred from the photoresist layer 132 to layer 128 and subsequently to layer 114 by wet or dry chemical etch processes. A deep reactive ion etch is performed to create channels 134, 136 (FIG. 6) to a depth within the substrate 112 of between 5.0 to 100.0 micrometers, for example. The channels 134, 136 preferably have a 1:10 aspect ratio with minimum feature size of 10 micrometers or smaller. The photoresist 132 is then removed using a chemical etch or calcinations, for example. A second metal layer 138 is formed and patterned on the etch stop film 128 for providing contacts to elements described hereinafter (alternatively, a lift-off process could be used). The metal layer 138 may have a thickness in the range of 0.01-1.0 micrometers, but preferably is 0.1 micrometers. Metals for the metal layer 138 preferably comprise copper, but may comprise, e.g., gold, platinum, silver, palladium, ruthenium, and nickel.

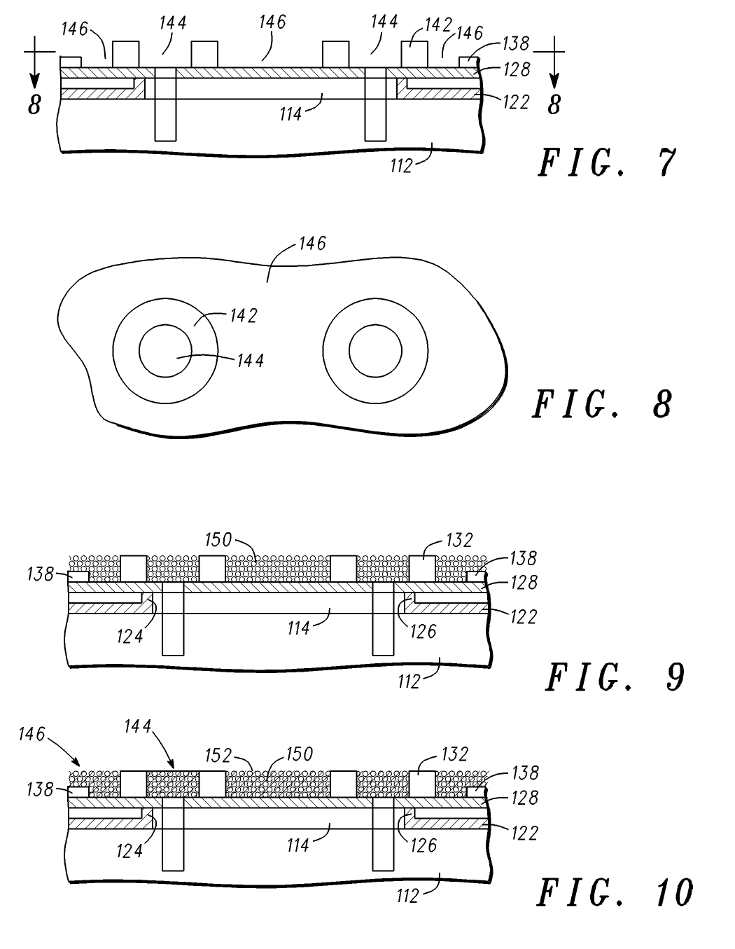

One method of forming anodes/cathodes over the conductive film 128 will now be described. Referring to FIGS. 7 and 8, another photoresist 142 is formed in a pattern to create the opening 144 and a concentric circular channel 146 to a depth of between 5.0 to 100.0 micrometers, for example. A plurality of beads 150 are dispensed (FIG. 9), by suspension for example, in the openings 144 and the circular channel 146 to the height of the photoresist 142. The beads 150 are generally spherical in shape, and though they each typically contact adjacent beads, space exists between the beads 150. The beads 150 preferably comprise polymers such as polystyrene, melamine, polymethylmethacrylate, but may also comprise inorganic beads, for example silica.

A metal 152 (FIG. 10) is placed, by an electroplating bath for example, in the openings 144 and circular channels 146 not occupied by the beads 150 (in the space between the beads 150 from commercial gold plating solutions by applying a potential between 0.8 and 1.6 volts. In addition to electrochemical deposition, metal can be deposited in the void spaces of the colloidal template using electroless plating processes, ion spraying, or laser spraying. Using still other methods, conductive carbon can be also deposited in the interstitial spaces instead of a metal. The beads 150 are then removed by chemical etching or calcinations, for example by heating in a toluene solvent for polymer beads, or etching with dilute HF for silica beads, thereby leaving a porous conductive structure 154 in each of the openings 144 and circular channels 156 (FIG. 11). The porous conductive structure 154 created by this method defines cavities, or open areas within the porous structure 154, on a macro scale as defined by the International Union of Pure Applied Chemistry (IUPAC). The IUPAC defines macroporous as comprising openings greater than 50.0 nanometers, microporous as comprising openings less than 2.0 nanometers, and mesoporous as comprising openings between 2.0 and 50.0 nanometers. It should be understood that any templated process for creating a fuel cell may be used with the present invention; however, it is intended the porous conductive structure 154 contain macroporous spaces. A method of forming porous structures using template assisted methods is described in U.S. application Ser. No. 11/669,720, Micro Fuel Cell Having Macroporous Metal Current Collectors, filed 31 Jan. 2007.

Referring to FIG. 11, the photoresist 132 is removed by known etching methods and the metal within layer 128 below the photoresist 132 is removed by ion milling techniques, thereby creating circular channels 156. Porous conductive structure 154 is coated within and on both sides of the circular channels 156 with an electrocatalyst layer 158 for anodic and cathodic fuel cell reactions. The process of applying the catalyst coating involves the following steps: preparation of a finely dispersed suspension of the carbon supported platinum in a suitable solvent, cleaning of the porous gold surfaces to remove any organic contaminants, and immersion of the porous gold into the catalyst particle suspension for a desired time to obtain sufficiently thick coating of the catalyst followed by rinsing in a solvent to remove the loosely bound catalyst particles from the porous gold and the oxide surfaces. When the gold material (pedestal 164) is immersed in a platinum carbon dispersion, the first layer of catalyst is adsorbed on gold is through the formation of carbon gold bonds. The next layer (build up in thickness) is due to the formation of bonds between adsorbed carbon on the substrate and surrounding carbon particles, or agglomerates, with platinum in the dispersion. Strong carbon-carbon bonds form upon drying.

The process to prepare a fine suspension of the catalyst powder in a suitable suspension is described herein. For example, any of the commercially available catalyst powers such as 40 wt % platinum supported on high surface area carbon power, 60 wt % platinum supported on Carbon from Johnson Matthey or other suppliers can be used in this process. Suitable solvents for preparing the suspension are isopropyl alcohol, water, isopropyl alcohol/water mixture and other organic solvents such as acetone, toluene, hexanol, cyclohexane. Isopropyl alcohol provides the most stable dispersion, but it needs to be handled in an inert atmosphere in a glove box to avoid accidental ignition when the catalyst is mixed with the isopropyl alcohol. Water suspensions are very safe, but the quality of dispersion of the platinum/carbon catalyst is not as stable in water compared to the isopropyl alcohol. A mixture of water and isopropyl alcohol provided an intermediate compromise with good stability of the suspension and safety. The method of preparing the suspension involves a step wise dispersion of the catalyst power with increasing dilutions in the solvent using a high shear ultrasonic horn. The purpose of this ultrasonic dispersion is to break down the agglomerates within the catalyst power and making more high surface area primary particles for effective catalyst coating. However, there is an optimum time and ultrasonic power for dispersion these powders. Excessive exposure to high power ultrasonic energy can dissociate the platinum particles from their carbon support which is not desirable. After preparing the suspension it is desirable to apply the catalyst coating immediately to avoid re-agglomeration and settling of the catalyst particles in the suspension. Shelf life of these suspensions without the addition of any surfactants is not very good, so it is desirable to prepare fresh suspensions or require re-dispersion of the previously prepared suspensions before use.

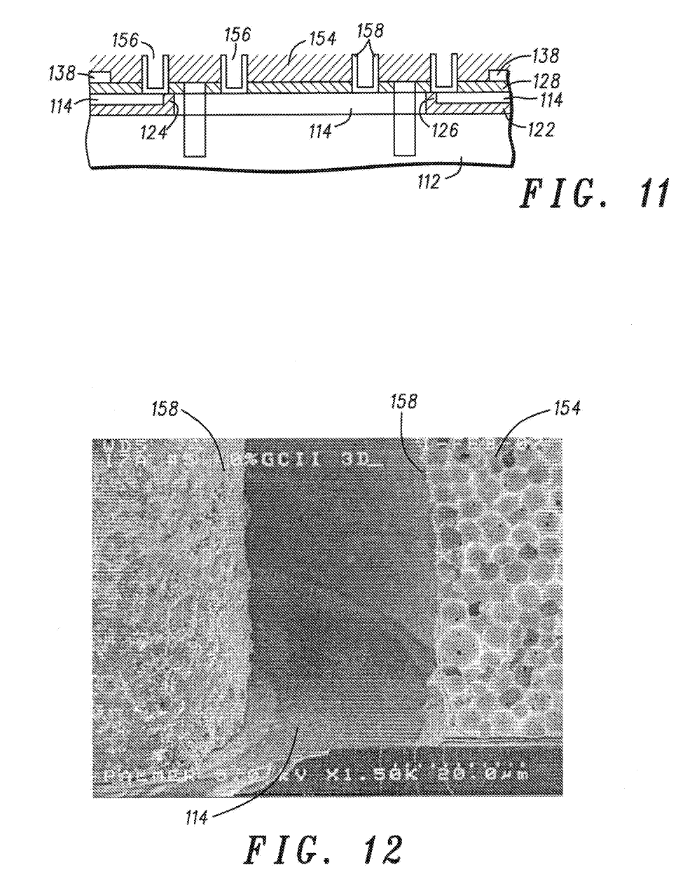

To achieve optimum catalyst coating on the porous gold surfaces, sample surface pretreatment is required before applying the electrocatalyst coating process. Cleaning the sample in Piranha solution (H₂SO₄: H₂O₂=4:1 @ 98° C., for 10 minutes) or cleaning the sample in UV ozone cleaner for 30-60 minutes will remove the organic contaminants from the porous gold surface leaving it more hydrophilic which is desirable for adsorbing the catalyst. The catalyst coating process involves dipping the sample in the suspension for a certain period of time and then rinsing in a solvent, e.g., distilled water, or multiple dippings alternatively in the catalyst suspension and the solvent until a desired catalyst coating thickness is achieved. In this process, since the adhesion of the catalyst particles on the oxide surfaces is poor compared to the freshly cleaned gold surface areas, the catalyst particles adheres strongly on the gold surfaces and the catalyst from the undesired oxide surfaces can be easily washed away. Scanning electron microscopic examination of the catalyst coating and electrochemical surface area measurements on the coated layer were used to determine the optimum catalyst coating parameters. When the gold material is removed from the dispersion, there is a thin layer of the dispersion adhering to the surface of the gold. As the solvent evaporates, strong carbon-carbon bonds are established, readily and randomly even bridging (sometimes leading to shorting) the anodes and cathodes. Immediate rinsing causes most of these undesirable carbon-carbon bonds to be washed away, minimizing shorting but also significantly reducing the thickness. The steps of, depending on the suspension and solvent used, immersing in a platinum supported carbon catalyst powder dispersion and washing may be repeated several times. The repeated washings after a short duration in the catalyst powder dispersion forms an increasingly thicker electrocatalyst layer on the gold material while keeping the dielectric layer “clean” of the electrocatalyst and of agglomerates. FIG. 12 is a picture, after washing, of the electrocatalyst layer 158 disposed on the gold material 154 and shows the dielectric layer 114 without any (or very little) electrocatalyst thereon.

It is well known in the fuel cell literature that adding a small quantity of ionomer to the catalyst mix will increase the performance of the fuel cell compared to the catalyst power alone, by providing more triple-phase contacts of catalyst on an electronic conductor, fuel gas and an ionic conductor connected to the electrolyte by providing easy transport path for the protons. In the current method of electrocatalyst coating process, the incorporation of ionomer component such as Nafion® to the catalyst coat can be accomplished by adding the ionomer in the form of a dilute Nafion solution to the catalyst suspension. However, this method of adding ionomer to the catalyst suspension will expose gold to both ionomer and catalyst, resulting in less Pt loading as well as the adhesion of the catalyst to the oxide and it can not be easily washed out. In this case the polymer component (ionomer) in the catalyst mix bonds very strongly to the oxide layer and also to the catalyst particles and can not be easily washed away. This will create electronic short across the anode and cathode portions of the fuel cell and it is not desired. However, a suitable method to incorporate the ionomer into the catalyst coating involves first forming the catalyst coating without adding the ionomer into the catalyst suspension as described earlier, and followed by dipping the sample in a dilute solution containing only the ionomer component. Since the catalyst coating is porous it has been observed that the ionomer diffuses into the catalyst layer forming a three-phase contact which increases the performance of the electrocatalyst for fuel cell use. The ionomer coated on the oxide layer in this process is harmless since it does not contain any electronic conducting components (catalyst particles).

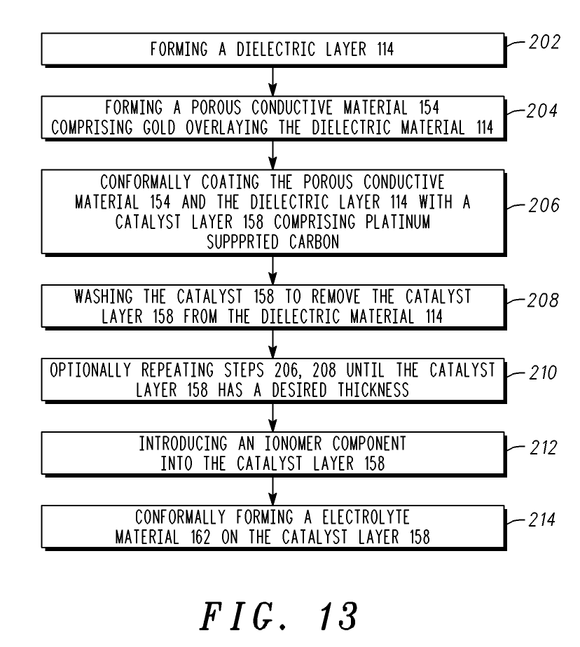

This procedure is illustrated in the flow chart of FIG. 13, wherein the dielectric layer 114 is formed 202 and a gold porous conductive material 154 is formed 204 thereover. The porous conductive material 154 and the dielectric layer 114 are conformally coated 206 with the catalyst layer 158 of carbon supported platinum. The catalyst 158 is washed 208, thereby removing it from the dielectric layer 114, but since the catalyst 158 has bonded to the gold 154, most of the catalyst 158 remains on the gold 154. These coating and washing steps 206, 208 optionally may be repeated 210 several times, depending on the suspension and washing solution, to improve the quality of the coating on the gold. A dilute solution containing only an ionomer component is applied to the catalyst layer 158 which diffuses 212 into the catalyst layer 158. An electrolyte material 162 is then formed 214 on the catalyst layer over the gold 154.

Results from the above described coating process are shown in the following tables. Table 1 shows the influence of solvent type on the catalyst loading measured by cyclic voltammetry.

TABLE 1

| SAMPLE | ERS (cm²) |
|---|---|
| Pt-C 4 IPA | 20.1 |
| Pt-C 3 20% | 10.6 |
| Pt-C 2 water | 0.14 |

*ERS: electrochemical real surface. Piranha cleaning, H₂SO₄: H₂O₂=4:1, 98° C., 10 min. 0.92 mg/ml, 40% Pt/C, 24 hr.
Therefore, IPA is the best solvent to disperse carbon supported platinum and to coat the gold surface.

Table 2 shows the influence of ultrasonication power on the catalyst loading measured by cyclic voltammetry.

TABLE 2

| SONIC POWER (W) | ERS (cm²) |
|---|---|
| 550 | 130 |
| 45 | 40 |

Solvent: IPA, Catalyst loading: 2 mg/ml, dip time: 20 hr

### (Ultrasonicator Horn: Misonix Sonicator)

It may be concluded from these results that a higher sonication power is desired to disperse the carbon supported platinum into IPA solution.

Table 3 shows the influence of ultrasonication time on the catalyst loading measured by cyclic voltammetry.

TABLE 3

| SONICATION TIME (MIN) | ERS (cm²) |
|---|---|
| 30 | 20.1 |
| 70 | 18.2 |

Sample cleaned in Piranha solution (H₂SO₄: H₂O₂=4:1), @ 98° C., 10 min. Catalyst loading: 0.92 mg/ml, Catalyst type: 40% Pt/C, Time: 24 hr. Dispersion Solvent: IPA
Therefore, a sonication time of 30 minutes should be sufficient to disperse carbon supported platinum into IPA.

Table 4 shows the sequence of introduction of Nafion into the catalyst. Catalyst loading is measured by cyclic voltammetry.

TABLE 4

| SAMPLE | ERS (cm²) |
|---|---|
| without Nafion | 130 |
| separated | 92 |
| together | 1.90 |

Sample cleaned in Piranha solution (H₂SO₄: H₂O₂=4:1), @ 98° C., 10 min. Catalyst loading: 2 mg/ml, Catalyst type: 40% Pt/C, [Nafion]: 1.25%. Dip Time: 20 hr. Dispersion Solvent: IPA
Therefore, coating carbon supported platinum on the electrodes first, then introducing Nafion will provide a triple-phase contact of carbon (electron conducting material), platinum (hydrogen dissociation catalyst), and ionomeric membrane (Nafion).

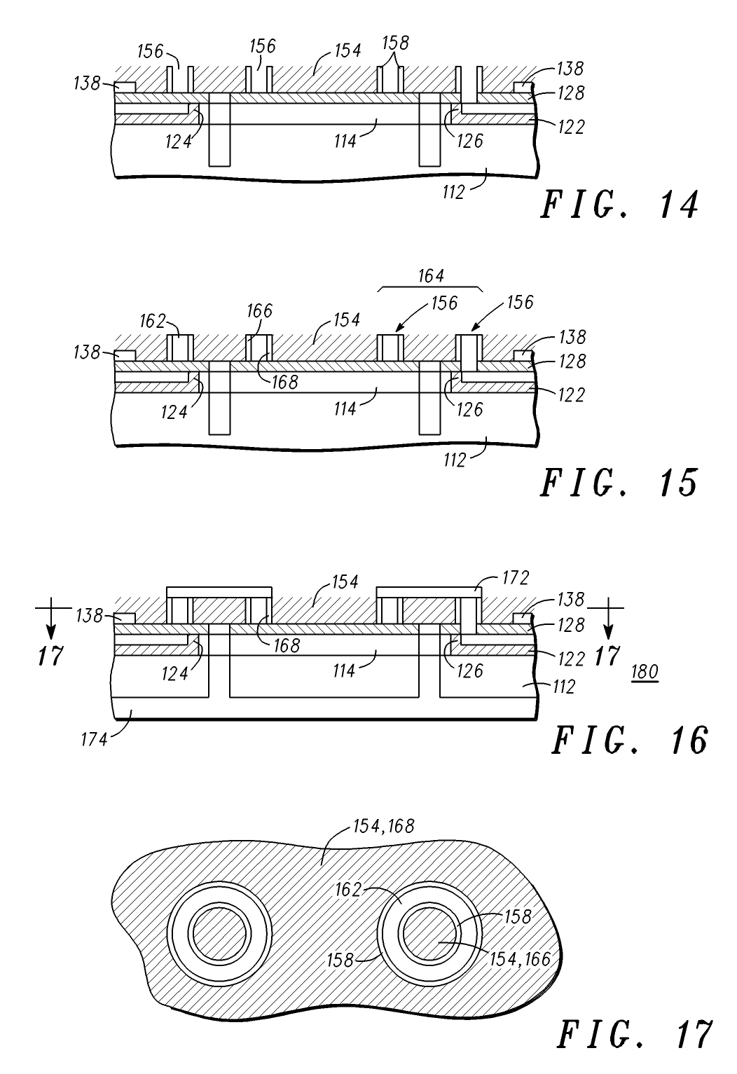

After forming the electrocatalyst on the porous gold surfaces of the anode and cathode walls, the next step is to fill the gaps between the anode and cathode with a proton conducting electrolyte material such as Nafion. An electrolyte 162 is formed within the circular channels 156 (FIG. 14), resulting in a pedestal 164 comprising a center anode 166 (inner section), and a concentric cathode 168 (outer section) surrounding and separated by the electrolyte 162 from the anode 166 (FIGS. 15 and 17). Concentric as used herein means having a structure having a common center, but the anode, cavity, and cathode walls may take any form and are not to be limited to circles. For example, the pedestals 164 may alternatively be formed by etching orthogonal trenches. The pedestal 164 preferably has a diameter of 10 to 100 microns. The distance between each pedestal 164 would be 10 to 100 microns, for example. The electrolyte material 162 may comprise any insulating material with sufficient protonic conductivity to perform as a fuel cell membrane, for example, perfluorosulfonic acids (such as, but not limited to, Nafion®), phosphoric acid, hydrogels, polysulfonic and polyphosphonic polymers or mixtures, ionic liquid electrolytes, organic-inorganic hybrid materials, and proton-conducting inorganic materials. Perfluorosulfonic acid has a very good ionic conductivity (0.1 S/cm) at room temperature when humidified. The electrolyte material also can be a proton conducting ionic liquids such as a mixture of bistrifluoromethane sulfonyl and imidazole, ethylammoniumnitrate, methyammoniumnitrate of dimethylammoniumnitrate, a mixture of ethylammoniumnitrate and imidazole, a mixture of elthylammoniumhydrogensulphate and imidazole, fluorosulphonic acid and trifluoromethane sulphonic acid. The incorporation of the electrolyte film can be accomplished by pouring the Nafion® in liquid form and filling only at the desired areas using a suitable gasket. Other methods such as ink jet printing may be used to incorporate the Nafion. The polyelectrolyte is dried to form a solid polymer electrolyte film between the anode and cathode portions, and the filling steps are repeated until those circular channels are fully filled.

In accordance with the exemplary embodiment, the electrocatalyst layer 158 is washed using, for example, water or an alcohol solution. Most of the catalyst settled on the dielectric material, e.g., silicon dioxide, is removed by gentle washing, even after complete drying since carbon-silicon binding energy is very weak.

This procedure is illustrated in the flow chart of FIG. 13, wherein the dielectric layer 114 is formed 202 and a gold porous conductive material 154 is formed 204 thereover. The porous conductive material 154 and the dielectric layer 114 are conformally coated 206 with the catalyst layer 158 of carbon supported platinum. The catalyst 158 is washed 208, thereby removing it from the dielectric layer 114, but since the catalyst 158 has bonded to the gold 154, most of the catalyst 158 remains on the gold 154. An electrolyte material 162 is then formed 214 within the circular channels 156.

A capping layer 172 is formed (FIG. 16) and patterned above the porous metal 154, to enclose the anode/fuel regions, and the electrolyte material 162. A planning step is performed to reduce the thickness of the substrate 112 and expose the vias 134 and 136. The silicon substrate 112, or the substrate containing the micro fuel cells, is positioned on a structure (gas manifold) 174 for transporting hydrogen to the channels 134, 136. The structure 174 may comprise a cavity or series of cavities (e.g., tubes or passageways) formed in a ceramic material, for example. Hydrogen would then enter the anode/hydrogen sections 166 above the cavities 134, 136. Since anodes 166 are capped with the capping layer 172, the hydrogen would stay within the sections 166. Cathode/oxidant sections 168 are open to the ambient air, allowing air (including oxygen) to enter oxidant sections 168.

The exemplary embodiment disclosed herein provides a method of fabricating a fuel cell having three dimensionally ordered materials, while increasing the surface area for a gas to access the anode material, eliminating constraints on wafer size and thickness, and providing for sub-twenty micron vias for gas access to each cell for increasing cell, and hence, power density. The macrosized current collectors provide controlled pore dimensions with tailored surface chemistry providing for improved hydrophobicity-hydrophilicity for better water management, three-phase boundary between electrocatalyst, current collector, and electrolyte, and reduced iR losses.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of selectively coating a catalyst layer on an electrode of a fuel cell, comprising:
forming a porous conductive material comprising gold overlying a portion of a dielectric material to form the electrode;
coating the porous conductive material and the dielectric material with the catalyst layer comprising a carbon supported platinum;
washing the catalyst layer to substantially remove the catalyst layer from the dielectric material; and
filling the catalyst coated circular channels with an electrolyte layer.

2. The method of claim 1 further comprising applying a solution containing an ionomer component after the washing step and prior to the filling the electrolyte step.

3. The method of claim 2 wherein the washing step comprises rinsing the catalyst layer with a solvent.

4. The method of claim 1 wherein the coating the porous conductive material and the washing steps are repeated in sequence.

5. The method of claim 4 further comprising applying a solution containing an ionomer component after the final washing step.

6. The method of claim 1 wherein the washing step comprises rinsing the catalyst layer with a solvent to substantially remove the catalyst layer from the dielectric layer while substantially not affecting the catalyst layer on the porous conductive layer due to a strong bond therebetween.

7. The method of claim 1 wherein the coating the porous conductive material with electrocatalyst comprises:
preparing a suspension of the carbon supported platinum;
cleaning the porous conductive material surfaces; and
immersing the porous conductive material in the suspension.

8. A method of selectively coating a catalyst layer onto an electrode of a fuel cell, comprising:
forming a porous electrode comprising gold partially overlying a dielectric layer;
coating the porous electrode and the dielectric layer with a catalyst layer comprising one or more materials that are electrically and ionically conductive;
washing the catalyst layer to remove the catalyst layer from the dielectric layer but not from the porous electrodes; and
filling the catalyst layer with a proton conducting material.

9. The method of claim 8 further comprising applying a solution containing an ionomer component after the washing step and prior to the filling the electrolyte step.

10. The method of claim 9 wherein the washing step comprises rinsing the catalyst layer with a solvent.

11. The method of claim 8 wherein the coating the porous conductive material and the washing steps are repeated in sequence.

12. The method of claim 11 further comprising applying a solution containing an ionomer component after the final washing step.

13. The method of claim 8 wherein the washing step comprises rinsing the catalyst layer with a solvent to substantially remove the catalyst layer from the dielectric layer while substantially not affecting the catalyst layer on the porous conductive layer due to a strong bond therebetween.

14. The method of claim 8 wherein the coating the porous conductive material comprises:
preparing a suspension of the carbon supported platinum;
cleaning the porous conductive material surfaces; and
immersing the porous conductive material in the suspension.

15. A method of forming a fuel cell having a selectively coated catalyst, comprising:
forming first and second electrical conductors accessible at a first side of a substrate;
etching the substrate to provide a plurality of channels;
patterning a macroporous template comprising gold over the first side of the substrate to form a plurality of anode current collectors in contact with the first electrical conductor, and a plurality of cathode current collectors in contact with the second electrical conductor, one each of the plurality of anode current collectors formed over one of the plurality of channels, the substrate and each of the anode current collectors and the cathode current collectors defining a void therebetween;
coating the surface of the macroporous template and the dielectric material adjacent the void with a catalyst layer comprising a carbon supported platinum;
washing the catalyst layer to substantially remove the catalyst layer from the dielectric material; and
depositing an electrolyte within the void against the catalyst layer and between each of the plurality of anode current collectors and each of the plurality of cathode current collectors; and
capping the plurality of anode current collectors on a side opposed to the first side of the substrate.

16. The method of claim 15 further comprising applying a solution containing an ionomer component after the washing step and prior to the depositing step.

17. The method of claim 16 wherein the washing step comprises rinsing the catalyst layer with a solvent.

18. The method of claim 15 wherein the coating and the washing steps are repeated in sequence.

19. The method of claim 18 further comprising applying a solution containing an ionomer component after the final washing step.

20. The method of claim 15 wherein the washing step comprises rinsing the catalyst layer with a solvent to substantially remove the catalyst layer from the substrate while substantially not affecting the catalyst layer on the macroporous template due a strong bond therebetween.

21. The method of claim 15 wherein the coating step comprises:
preparing a suspension of the carbon supported platinum;
cleaning the porous conductive material surfaces; and
immersing the porous conductive material in the suspension.
